(19) United States
(12) Patent Application Publication
(10) Pub. No.: US 2014/0096007 A1
(43) Pub. Date: Apr. 3, 2014

(54) INFORMATION PROCESSING APPARATUS AND IMAGE MANAGEMENT METHOD

(71) Applicant: KABUSHIKI KAISHA TOSHIBA, Tokyo (JP)

(72) Inventors: Ryunosuke Itoh, Funabashi-shi (JP); Isao Kiji, Tokyo (JP); Tetsuya Gotou, Tokyo (JP); Chizuko Shimamura, Tokyo (JP); Katsunori Yokode, Tokyo (JP); Takashi Harada, Yokohama-shi (JP); Noriaki Koyama, Tokyo (JP)

(21) Appl. No.: 13/935,934

(22) Filed: Jul. 5, 2013

(30) Foreign Application Priority Data
Sep. 28, 2012 (JP) 2012-217722

(51) Int. Cl. G06F 17/30

(52) U.S. Cl. CPC G06F 17/30244
USPC 715/732

(57) ABSTRACT

According to one embodiment, an information processing apparatus includes an image storing processor, a slide show transmitter and a comment receiver. The image storing processor receives an image from clients and stores first images including the received image. The slide show transmitter generates a slide show including second images of the first images and transmits the slide show including the second images in a first order to a first client. The comment receiver receives from the first client comments associated with images of the second images. The slide show transmitter alters the slide show such that the slide show includes the second images in a second order based on the comments and transmits the altered slide show to a second client.

### CROSS-REFERENCE TO RELATED APPLICATIONS

This application is based upon and claims the benefit of priority from Japanese Patent Application No. 2012-217722, filed Sep. 28, 2012, the entire contents of which are incorporated herein by reference.

### FIELD

Embodiments described herein relate generally to an information processing apparatus which manages images, and an image management method used in the information processing apparatus.

### BACKGROUND

In recent years, various electronic devices, such as a personal computer, a smartphone, a mobile phone and a digital camera, have been gaining in popularity. Such electronic devices have a function of managing images such as photos. As an image management method, for example, there is known a method of classifying photos into a plurality of groups, based on photographing date/time data attached to the photos.

In addition, attention has recently been paid to a moving picture creation technique of creating a moving picture (e.g. slide show) using images such as photos. As the moving picture creation technique, for example, there is known a technique of selecting, from among a plurality of images, images having photographing date/time data corresponding to a designated date, and displaying the selected images in a sequential manner.

However, if plural images are simply displayed in a sequential manner, it is highly possible that an interest or unpredictability is deficient. Thus, there has been proposed, for example, a method in which features of music and features of images, which are used in a slide show, are analyzed, and a slide show is automatically created based on the analysis result.

However, it is unclear whether the automatically created slide show actually attracts an interest of a user, and it is also unclear in which of the photos used in the slide show the user will have an interest.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view for describing a slide show sharing system including a first client apparatus, a second client apparatus and an information processing apparatus (server) according to an embodiment.

FIG. 2 is an exemplary view for explaining a comment added to an image in the slide show in the slide show sharing system of FIG. 1.

FIG. 3 is an exemplary block diagram illustrating a system configuration of the information processing apparatus of the embodiment.

FIG. 4 is an exemplary block diagram illustrating a system configuration of the second client apparatus (digital television receiver) of FIG. 1.

FIG. 5 is an exemplary view illustrating an external appearance of a remote controller for operating the second client apparatus of FIG. 1.

FIG. 6 is an exemplary block diagram illustrating a functional configuration of the slide show sharing system of FIG. 1.

FIG. 7 is a view illustrating a configuration example of photo data used by the information processing apparatus of the embodiment.

FIG. 8 is a view illustrating a configuration example of slide show data used by the information processing apparatus of the embodiment.

FIG. 9 is a view illustrating a configuration example of photo association data used by the information processing apparatus of the embodiment.

FIG. 10 is a view illustrating a configuration example of comment data used by the information processing apparatus of the embodiment.

FIG. 11 is a view illustrating a configuration example of comment association data used by the information processing apparatus of the embodiment.

FIG. 12 is a view illustrating an example of a slide show creation screen displayed by the first client apparatus of FIG. 1.

FIG. 13 is a view illustrating an example of a thumbnail screen displayed by the first client apparatus or second client apparatus of FIG. 1.

FIG. 14 is a view illustrating another example of the thumbnail screen displayed by the first client apparatus or second client apparatus of FIG. 1.

FIG. 15 is a view illustrating an example of a slide show playback screen including comments, which is displayed by the first client apparatus or second client apparatus of FIG. 1.

FIG. 16 is a view illustrating an example of a slide show playback screen including a comment menu, which is displayed by the first client apparatus or second client apparatus of FIG. 1.

FIG. 17 is a view illustrating an example of a slide show playback screen including a comment input screen, which is displayed by the first client apparatus of FIG. 1.

FIG. 18 is an exemplary flowchart showing a process procedure of uploading photos from the first client apparatus of FIG. 1 to the information processing apparatus (server) of the embodiment.

FIG. 19 is an exemplary flowchart showing a process procedure of creating a slide show in response to a request by the first client apparatus of FIG. 1, the process procedure being executed by the information processing apparatus (server) of the embodiment.

FIG. 20 is an exemplary flowchart showing a process procedure of transmitting thumbnails of a slide show in response to a request by the first client apparatus or second client apparatus of FIG. 1, the process procedure being executed by the information processing apparatus (server) of the embodiment.

FIG. 21 is an exemplary flowchart showing a process procedure of adding a comment to an image in a slide show by using a comment which has been transmitted by the first client apparatus or second client apparatus of FIG. 1, the process procedure being executed by the information processing apparatus (server) of the embodiment.

### DETAILED DESCRIPTION

Various embodiments will be described hereinafter with reference to the accompanying drawings.

In general, according to one embodiment, an information processing apparatus includes an image storing processor, a slide show transmitter and a comment receiver. The image storing processor is configured to receive an image from one or more client apparatuses connected via a network, and to store first images including the received image. The slide show transmitter is configured to generate a slide show including second images selected from the first images and to transmit the slide show to a first client apparatus of the one or more client apparatuses, the slide show including the second images in a first order. The comment receiver is configured to receive one or more comments from the first client apparatus, wherein the one or more comments are associated with one or more images of the second images. The slide show transmitter is configured to alter the slide show such that the slide show includes the second images in a second order based on the one or more comments, and to transmit the altered slide show to a second client apparatus of the one or more client apparatuses.

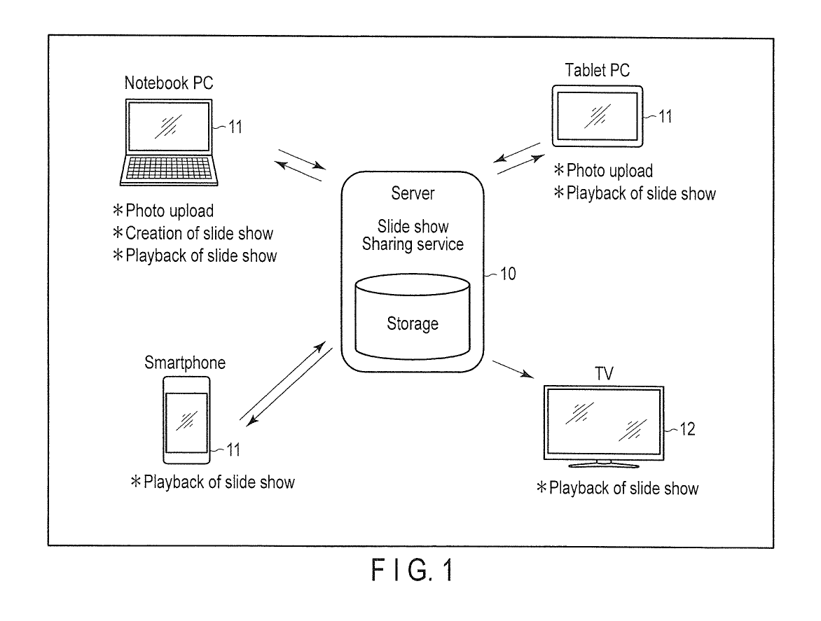

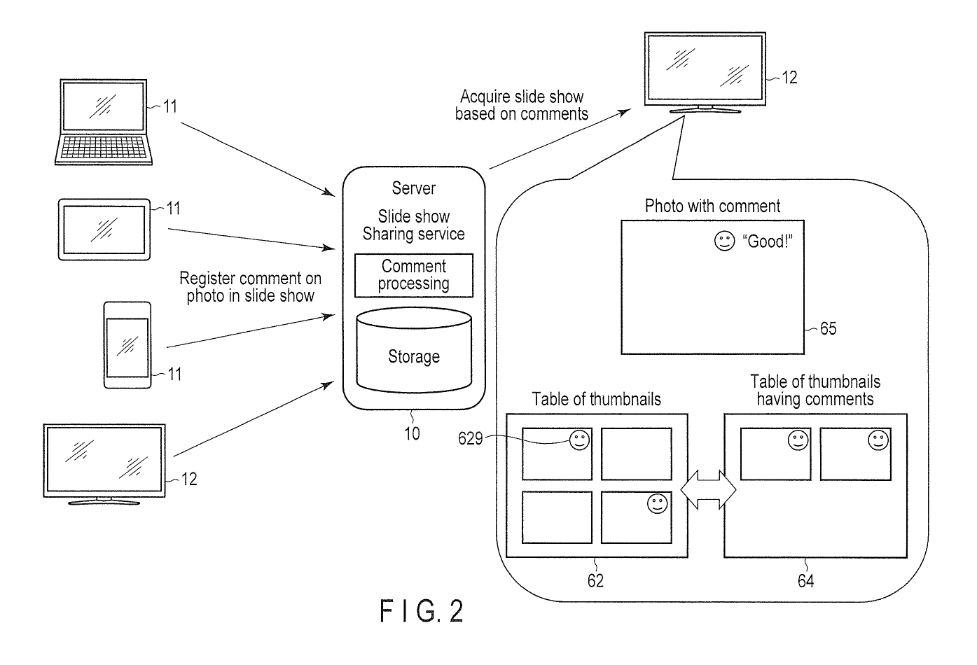

To begin with, referring to FIGS. 1 and 2, a description is given of the outline of the operation of a slide show sharing system including an information processing apparatus according to an embodiment. As illustrated in FIG. 1, in the slide show sharing system, a server 10, which is the information processing apparatus of the embodiment, provides a slide show sharing service to various types of client apparatuses. The client apparatuses include, for example, a first-type client 11 and a second-type client 12.

The first-type client 11 is realized, for example, as a notebook-type computer, a tablet-type computer, a smartphone, a PDA, or a mobile phone. The first-type client 11, in cooperation with the server 10, includes a photo upload function of uploading photo (image) data to the server 10, and a slide show playback function of playing a slide show downloaded from the server 10. The first-type client 11 may also include a slide show creation function of instructing (requesting) the server 10 to create a slide show using photos uploaded to the server 10.

The second-type client 12 is realized, for example, as a digital television receiver. The second-type client 12, in cooperation with the server 10, includes a slide show playback function of playing a slide show downloaded from the server 10.

The server 10 stores photo (image) data, which is uploaded from each of first-type clients 11, in storage. Then, in response to a request by the first-type client 11, the server 10 creates a slide show including designated photos, and stores data relating to the created slide show in the storage. The clients 11, 12 can share slide show. For example, the client 11, 12, which has been designated at a time of creation of the slide show, is permitted to play (download) the slide show. The server 10 delivers a certain slide show to the clients 11, 12 that share the slide show.

In addition, as illustrated in FIG. 2, the client 11, 12, in cooperation with the server 10, includes a comment function of adding a comment to the slide show which is being played. The client 11, 12 registers in the server 10 comments on respective photos in the slide show. Each of the comments is added to a photo in the slide show in accordance with a user's operation. The server 10 stores, in the storage, data relating to the comments added by the client 11, 12.

The server 10 can alter the slide show, based on the added comments. For example, the server 10 reconstructs the slide show so that a photo with a large number of added comments is preferentially displayed.

The client 11, 12 acquires the slide show based on the comments from the server 10. Then, when photos in the slide show are sequentially displayed, the client 11, 12 can display the comments added to each photo in such a manner that the comments are superimposed on each photo (photo with comment 65).

In addition, the client 11, 12 can also display, based on comments, thumbnails in a table format which correspond to photos in the slide show. The client 11, 12 can display a mark 629, which indicates that comments are added, on a thumbnail corresponding to a photo to which comments are added (thumbnail table 62), or can display only thumbnails corresponding to photos to which comments are added (thumbnail table with comments 64).

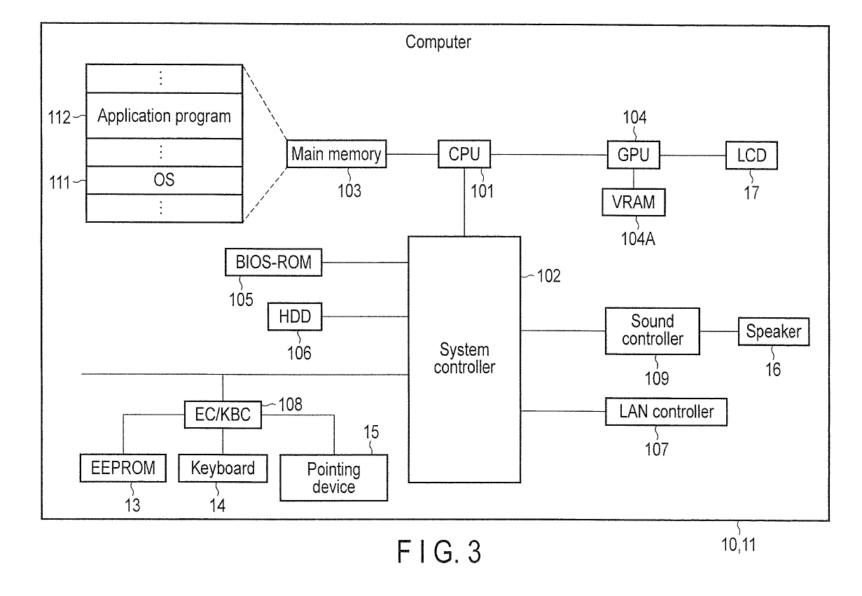

FIG. 3 illustrates an example of the system configuration of the server 10. The server 10 is realized, for example, as a server computer.

The computer 10 includes a CPU 101, a system controller 102, a main memory 103, a graphics processing unit (GPU) 104, a video memory (VRAM) 104A, a BIOS-ROM 105, an HDD 106, a LAN controller 107, an embedded controller/keyboard controller IC (EC/KBC) 108, a sound controller 109, an EEPROM 13, a keyboard 14, a pointing device 15, a speaker 16, and a display (LCD) 17. The respective components in the computer 10 are interconnected via internal buses.

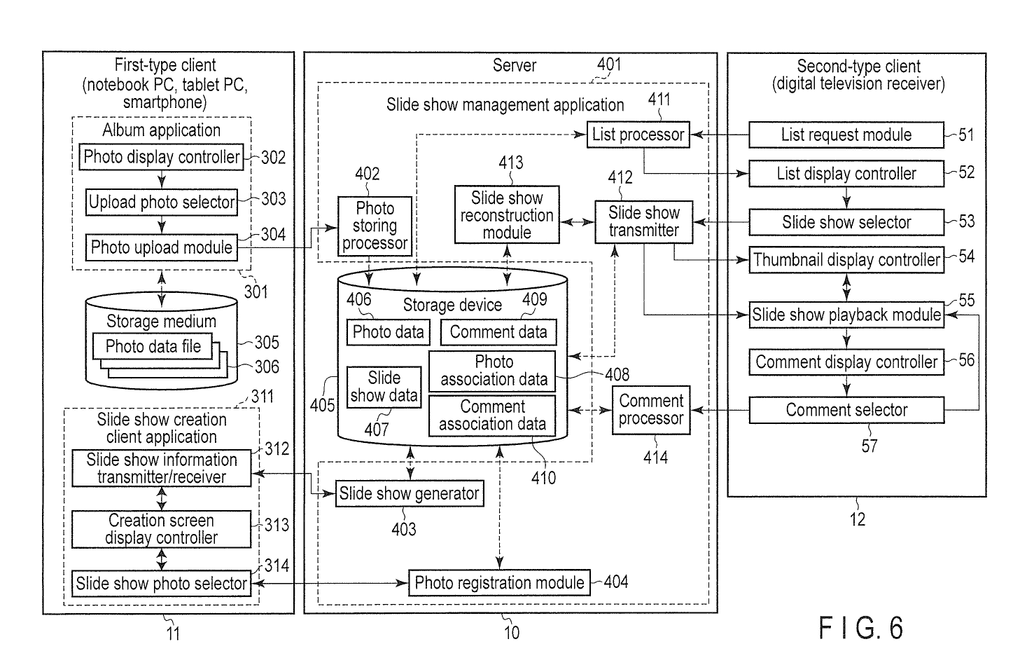

The CPU 101 is a processor which controls the operations of various modules in the computer 10. The CPU 101 executes various kinds of software, which are loaded from the nonvolatile memory 106 that is a storage device into the main memory 103. The software includes an operating system (OS) 111 and various application programs 112. The application programs include, for example, a slide show management program. The slide show management program is a program for managing a slide show which is played back by the client 11, 12. The slide show management program includes, for example, a function of creating a slide show by using images (photos) uploaded from the first-type client 11, a function of processing comments associated with images in the slide show on the client 11, 12, and a function of reconstructing the slide show based on the comments. The slide show management program will be described later with reference to FIG. 6.

The CPU 101 includes a memory controller which access-controls the main memory 103. In addition, the CPU 101 executes a basic input/output system (BIOS) stored in the BIOS-ROM 105. The BIOS is a program for hardware control.

The GPU 104 is a display controller which controls the LCD 17 used as a display of the computer. A display signal, which is generated by the GPU 104, is sent to the LCD 17.

The system controller 102 is a device which connects a local bus of the CPU 101 and various components. In addition, the system controller 102 includes a function of communicating with various components connected via, e.g. a serial bus of PCI EXPRESS serial standards or USB standards.

The sound controller 109 is a sound source device, and outputs audio data for playback to the speaker 16. The LAN controller 107 is a device configured to execute, for example, wired communication of Ethernet™ standards or wireless communication of IEEE 802.11 standards.

The embedded controller/keyboard controller IC (EC/KBC) 108 is a one-chip microcomputer in which an embedded controller for power management and a keyboard controller for controlling the keyboard (KB) 14 and pointing device 15 are integrated. The EC/KBC 108 has a function of powering on/off the computer 10 in accordance with the user's operation of a power button.

In addition, the first-type client 11 may be realized, for example, as a personal computer (desktop type, notebook type, tablet type, etc.), a smartphone, a PDA, or an embedded system which is incorporated in various electronic apparatuses. The first-type client 11 has a system configuration similar to the above-described server computer 10. The first-type client 11 may further include a camera module for taking photos, or a card reader for communicating with a memory card in which photo data is stored.

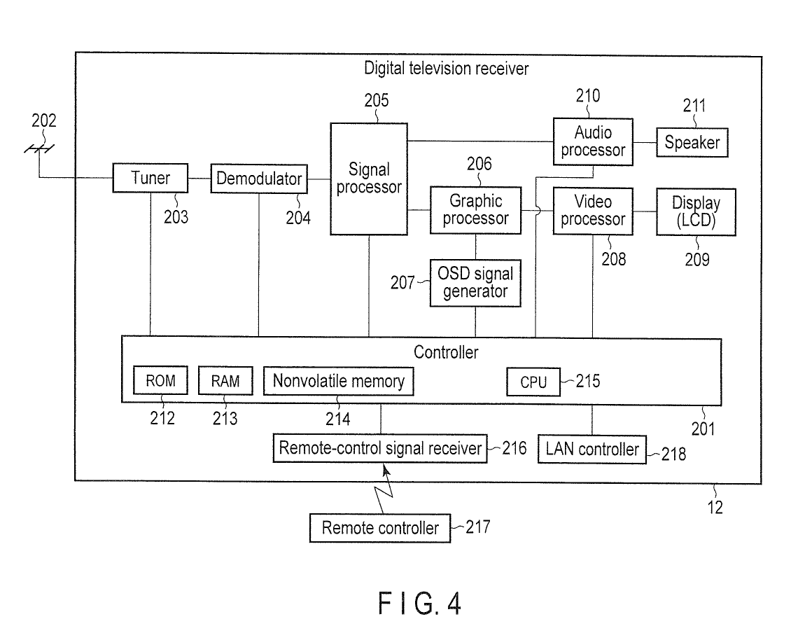

Next, FIG. 4 illustrates an example of the system configuration of the second-type client 12. The second-type client 12 is realized, for example, as a digital television receiver. Incidentally, the second-type client 12 may also be realized as various kinds of electronic apparatuses, such as a personal computer. In the description below, it is assumed that the second-type client 12 is realized as a digital television receiver.

The second-type client apparatus (digital television receiver) 12 includes a display (LCD) 209, a speaker 211, a remote-control signal receiver 216, a tuner 203, a demodulator 204, a signal processor 205, an audio processor 210, a graphic processor 206, a video processor 208, an OSD signal generator 207, a controller 201, and a LAN controller 218.

The controller 201 controls the operations of the respective components in the digital television receiver 12. The controller 201 includes a CPU 215, a ROM 212, a RAM 213 and a nonvolatile memory 214. The ROM 212 stores a control program executed by the CPU 215. The nonvolatile memory 214 stores various setting information and control information. The CPU 215 loads instructions and data, which are required for processes, in the RAM 213, and executes the processes.

A broadcast signal reception antenna 202 receives a digital television broadcast signal (e.g. terrestrial digital television broadcast signal, a satellite digital television broadcast signal, etc.). The broadcast signal reception antenna 202 outputs the received digital television broadcast signal to the tuner 203 via an input terminal. The tuner 203 selects from this broadcast signal a broadcast signal of a channel selected by the user. The tuner 203 outputs the selected broadcast signal to the demodulator 204 (e.g. an orthogonal frequency division multiplexing (OFDM) demodulator, phase shift keying (PSK) demodulator, etc.). The demodulator 204 demodulates the broadcast signal selected by the tuner 203 into a digital video signal and audio signal. The demodulator 204 outputs the demodulated digital video signal and audio signal to the signal processor 205.

The signal processor 205 subjects a predetermined digital signal processing on the digital video signal and audio signal output from the demodulator 204. The signal processor 205 outputs the subjected video signal and audio signal to the graphic processor 206 and audio processor 210.

The audio processor 210 converts the input digital audio signal to an analog audio signal which can be reproduced by the speaker 211. The audio processor 210 outputs this analog audio signal to the speaker 211. The speaker 211 reproduces audio based on the input analog audio signal.

The graphic processor 206 superimposes an on screen display (OSD) signal of, e.g. a menu, which is generated by the OSD signal generator 207, upon the digital video signal output from the signal processor 205. The graphic processor 206 outputs the video signal, on which the OSD signal has been superimposed, to the video processor 208. Besides, the graphic processor 206 may output either the video signal from the signal processor 205 or the OSD signal from the OSD signal generator 207.

The video processor 208 subjects a predetermined processing on the input digital video signal. This predetermined processing is, for example, a sharpening processing for sharpening the input digital video signal. The video processor 208 converts the subjected digital video signal to an analog video signal which can be displayed on the display 209. The video processor 208 outputs the analog video signal to the display 209. The display 209 displays video based on the input analog video signal.

The LAN controller 218 is a device configured to execute, for example, wired communication of Ethernet standards or wireless communication of IEEE 802.11 standards.

The remote-control signal receiver 216 receives a remote-control signal (e.g. an infrared signal) transmitted from a remote controller 217. The remote-control signal receiver 216 outputs the received remote-control signal to the controller 201.

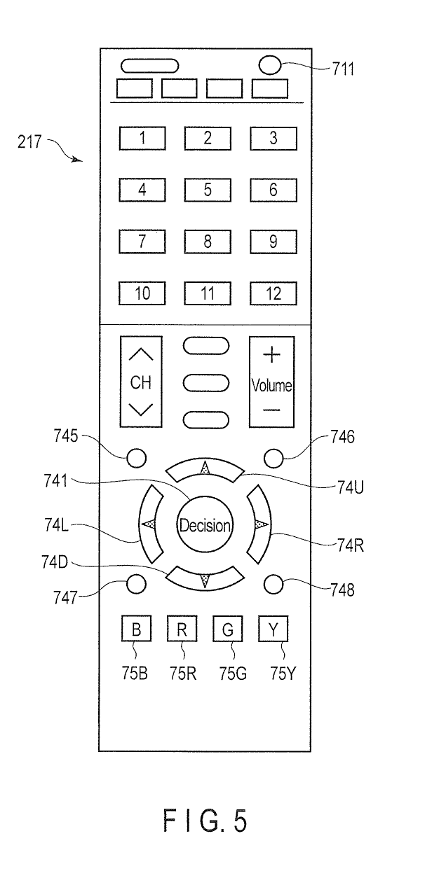

FIG. 5 illustrates an example of the external appearance of the remote controller 217 for inputting various remote-control signals transmitted to the remote-control signal receiver 216. In response to pressing of an operation button, the remote controller 217 transmits a remote-control signal corresponding to the operation button. The remote controller 217 includes a “power” button 711, a “decision” button 741, a “menu” button 745, a “program guide” button 746, a “back” button 747, and an “end” button 748. The remote controller 217 further includes an “up” button 74U, a “down” button 74D, a “left” button 74L, a “right” button 74R, a “blue” button 75B, a “red” button 75R, a “green” button 75G, and a “yellow” button 75Y.

The “power” button 711 is an operation button for switching between power-on (operating state) and power-off (standby state) of the digital television receiver 12. The “decision” button 741, “up” button 74U, “down” button 74D, “left” button 74L, “right” button 74R, “blue” button 75B, “red” button 75R, “green” button 75G, and “yellow” button 75Y are buttons for manipulating a menu displayed on the screen.

The “menu” button 745 is an operation button for displaying a menu screen for performing various settings. The “program guide” button 746 is an operation button for displaying a program guide. The “back” button 747 is an operation button for going back to a previous operation state in an operation process. The “end” button 748 is an operation button for terminating the present mode.

Next, FIG. 6 illustrates functional configurations of the server 10 and clients 11 and 12 in the slide show sharing system. The server 10 executes a slide show management application program 401 for sharing a slide show between the clients 11 and 12. The slide show management application program 401 includes a photo storing processor 402, a slide show generator 403, a photo registration module 404, a list processor 411, a slide show transmitter 412, a slide show reconstruction module 413, and a comment processor 414.

The first-type client 11 executes an album application program 301 for uploading photos to the server 10, and a slide show creation client application program 311 for creating a slide show by using the photos which are uploaded to the server 10. The album application 301 includes a photo display controller 302, an upload photo selector 303 and a photo upload module 304. The slide show creation client application 311 includes a slide show information transmitter/receiver 312, a creation screen display controller 313 and a slide show photo selector 314.

The second-type client 12 includes a list request module 51, a list display controller 52, a slide show selector 53, a thumbnail display controller 54, a slide show playback module 55, a comment display controller 56 and a comment selector 57.

In this slide show sharing system, the server 1 and client 11, 12 execute a photo upload phase, a slide show creation phase and a slide show display phase in cooperation with each other. In the photo upload phase, the first-type client 11 uploads photo (image) data to the server 10. In the slide show creation phase, the server 10 creates a slide show in response to a request by the first-type client 11. In the slide show display phase, the server 10 transmits data of a slide show to the client 11, 12 and the client 11, 12 displays the slide show or a thumbnail table of the slide show. These phases will be described below.

To begin with, the operations of the respective components in the photo upload phase are described.

The photo storing processor 302 of the album application 301 executed on the first-type client 11 displays a table of photos and directories (folders) in which the photos are stored. The user selects photos, which are to be uploaded to the server 10, from the table of photos and directories. The photos and directories in the displayed table are, for example, those stored in a predetermined directory in a storage medium 305.

The upload photo selector 303 selects designated photos, or photos stored in a designated directory, in accordance with a user's select operation. The upload photo selector 303 reads photo data files 306, which correspond to the selected photos, from the storage medium 305. Then, the photo upload module 304 transmits (uploads) the photo data files 306 to the server 10.

The photo storing processor 402 of the slide show management application 401 executed on the server 10 receives the photo data files transmitted from the client 11 (photo upload module 304), and then stores the photo data files in a storage device 405. Thus, a plurality of photos (first images), which have been uploaded from one or more clients 11, are stored in the storage device 405.

Subsequently, the photo storing processor 402 generates photo data 406 corresponding to the stored photos. Specifically, when a photo has been newly stored in the storage device 405, the photo storing processor 402 generates an entry corresponding to this photo, and adds the entry to the photo data 406.

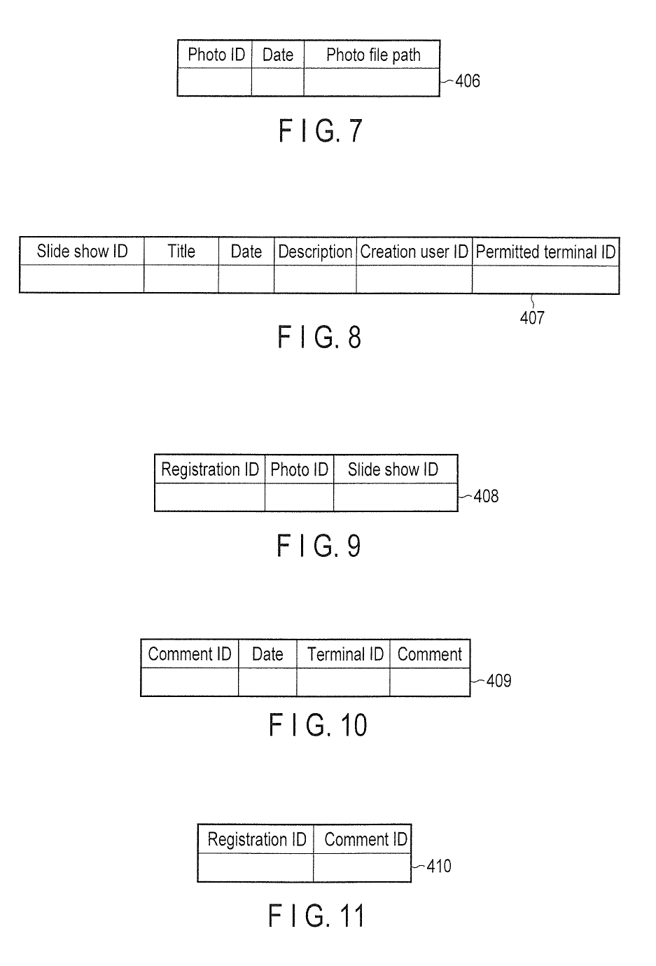

FIG. 7 illustrates a configuration example of the photo data 406 stored in the storage device 405. The photo data 406 includes a plurality of entries corresponding to a plurality of photos (images) which have been uploaded to the server 10. Each entry includes, for example, a photo ID, a date and a photo file path. In an entry corresponding to a certain photo, the “photo ID” is indicative of identification information given to the photo. The “date” is indicative of a date (or date/time) at which the photo was generated (taken). The “photo file path” is indicative of a storage location (file path) of the data file of the photo. Incidentally, this entry may further include a user ID of the photographer of the photo, and a user ID and a terminal ID of a user who can use the photo for the slide show.

By the above operation, a photo (photo data file), which has been transmitted from the first-type client 11, is stored in the server 10, and the photo data 406 corresponding to this photo is generated. For example, the user can upload a photo, which has been taken by using a smartphone at a place where the user has gone, to the server 10 from this place, or can upload photos as a set, which have been taken by using a digital camera, to the server 10 from a PC.

Next, the operations of the respective components in the slide show creation phase are described.

To begin with, the slide show information transmitter/receiver 312 of the slide show creation client application 311 executed on the first-type client 11 requests information for newly creating a slide show (hereinafter also referred to as “new creation information”) from the server 10, when new creation of a slide show has been requested by a predetermined user operation.

In response to the request by the client 11, the slide show generator 403 of the server 10 generates new creation information of a slide show. The slide show generator 403 generates, as the new creation information, for example, information indicative of candidates of client apparatuses that share the slide show. The candidates of client apparatuses include a predetermined range of client apparatuses (e.g. client apparatuses used by relatives, friends and acquaintances) among plural client apparatuses 11 and 12 connected to the server 10 over networks. In addition, the slide show generator 403 may also generate, as the new creation information, information indicative of candidates of BGM usable in the slide show, or information indicative of candidates of effects applied to photos in the slide show. The slide show generator 403 transmits the generated new creation information to the requested client 11.

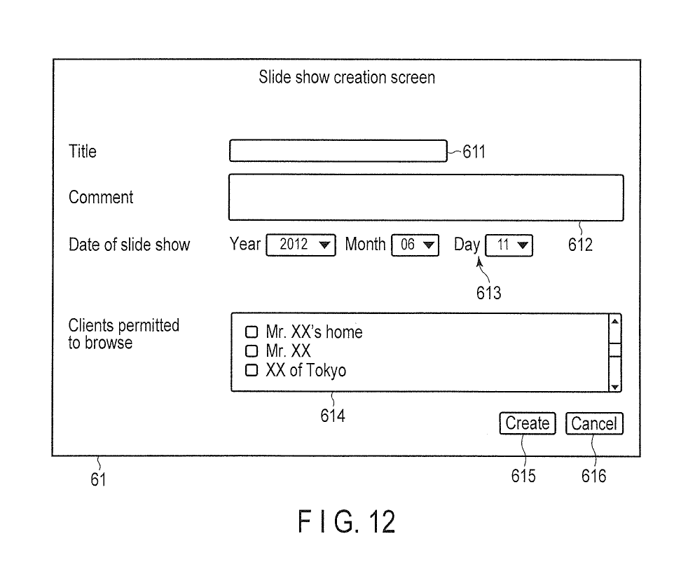

The slide show information transmitter/receiver 312 of the client 11 receives the new creation information and then outputs it to the creation screen display controller 313. Then, the creation screen display controller 313 displays a new creation screen of a slide show by using this new creation information. By using the keyboard or pointing device, the user inputs, on the new creation screen of the slide show, the title of the slide show to be created, a general description, and a date. The user also selects clients that share the slide show (i.e. clients that are permitted to play the slide show) from the candidates of client apparatuses (e.g. a list of nicknames given to the client apparatuses) based on the new creation information. An example of the new creation screen of a slide show will be described later with reference to FIG. 12.

In response to the completion of the input (selection) using the new creation screen, the slide show information transmitter/receiver 312 transmits the input information for slide show creation (hereinafter also referred to as “slide show creation information”) to the server 10 (slide show generator 403). This slide show creation information includes, for example, the title, general description and date of the slide show, the identification information (IDs or nicknames) of clients permitted to play the slide show and the identification information (user ID) of the user who instructed the creation of the slide show.

The slide show generator 403 of the server 10 creates a slide show by using the slide show creation information transmitted from the client 11 (slide show information transmitter/receiver 312). More specifically, the slide show generator 403 generates the slide show data 407, based on the slide show creation information. In other words, the slide show generator 403 generates an entry based on the slide show creation information, and then adds the entry to the slide show data 407.

FIG. 8 illustrates a structure example of the slide show data 407 stored in the storage device 405. The slide show data 407 includes a plurality of entries corresponding to a plurality of slide shows. Each entry includes, for example, a slide show ID, a title, a date, a description, a creation user ID, and a permitted terminal ID. In an entry corresponding to a certain slide show, the “slide show ID” is indicative of identification information given to this slide show. The “title” is indicative of the title of the slide show. The “date” is indicative of a date associated with the slide show (e.g. the date of an event in which photos for use in the slide show were taken). The “description” is indicative of a description relating to the contents of the slide show, and includes, for example, a general description, an introduction, etc. of the slide show. The “creation user ID” is indicative of identification information (e.g. user account) of a user who created the slide show. The “permitted terminal ID” is indicative of identification information (e.g. terminal ID or nickname) given to client terminals which are permitted to play (browse) the slide show.

In response to the completion of generation of the slide show (generation of the entry of slide show data 407), the slide show generator 403 generates data indicative of photos usable in the generated slide show (hereinafter also referred to as “usable photo data”). The usable photo data includes, for example, thumbnails of photos permitted to be used in the client 11 (e.g. photos uploaded from the client 11, photos uploaded by the user of the client 11, photos uploaded by a family member of the user of the client 11, etc.). The slide show generator 403 transmits the generated usable photo data to the first-type client 11.

The slide show information transmitter/receiver 312 of the client 11 receives the usable photo data from the server 10 (slide show generator 403) and then outputs it to the creation screen display controller 313. By using the usable photo data, the creation screen display controller 313 displays a table of photos (thumbnails) usable in the created slide show. Using the keyboard or pointing device, the user performs an operation of selecting photos (second images), which are used in the slide show, from the photos shown in the table. The slide show photo selector 314 determines photos used in the slide show, in accordance with a user's select operation. Then, the slide show photo selector 314 transmits information indicative of photos used in the slide show (e.g. identification information of selected photos) to the server 10 (photo registration module 404). In addition, the slide show photo selector 314 determines, in accordance with a user's operation, an order of display of the selected photos in the slide show, and transmits information indicative of the display order (first order) to the server 10.

Based on the information indicative of the photos used in the slide show and the display order of these photos which has been transmitted from the client 11 (third client), the photo registration module 404 of the server 10 generates a slide show which includes the photos (second images) selected by the client 11 in the first order. To be more specific, the photo registration module 404 generates an entry including photo IDs corresponding to the photos selected by the client 11 and a slide show ID corresponding to the created slide show, and adds the generated entry to photo association data 408.

FIG. 9 illustrates a configuration example of the photo association data 408 stored in the storage device 405. The photo association data 408 includes a plurality of entries corresponding to a plurality of combinations of slide shows and photos (images). Specifically, in the photo association data 408, combinations of slide shows and photos used in the slide shows are registered. Each entry includes, for example, a registration ID, a photo ID, and a slide show ID. In an entry corresponding to a certain combination, the “registration ID” is indicative of identification information given to this combination. The “photo ID” is indicative of identification information given to a photo that is used in this combination. The “slide show ID” is indicative of identification information given to a slide show that is used in this combination. Thus, by using the photo association data 408, it is possible to detect a photo (photos) used in a certain slide show, or to detect a slide show in which a certain photo is used. Incidentally, the entry of the photo association data 408 may further include information indicative of a display order of the photos indicated by the “photo ID” in the slide show indicated by the “slide show ID”.

By the above operation, the server 10 can generate a slide show in which photos designated by the client 11 are displayed in the first order.

Next, the operations of the respective components in the slide show display phase are described.

To begin with, the list request module 51 of the second-type client 12 requests the server 10 to transmit a list of slide shows which can be played back (browsed) by the client 12.

The server 10 can transmit a certain slide show to a permitted client among one or more clients 11, 12 connected to the server 10. In response to the request by the client 12, the list processor 411 of the server 10 generates a list of slide shows which can be played by the client 12, by referring to the slide show data 407 in the storage device 405. Specifically, the list processor 411 extracts entries in which the identification information (terminal ID or nickname) of the client 12 is in the “permitted terminal ID” from the slide show data 407 and then generates a list of slide shows which can be played by the client 12. The list processor 411 transmits the generated list to the client 12.

The list display controller 52 of the client 12 receives the list from the server 10, and displays the list on the screen of the client 12. The displayed list includes, for example, a list of titles of slide shows which can be played. Using the displayed list, the user performs an operation of selecting a slide show which is to be played. In response to the user's operation, the slide show selector 53 determines the slide show that is to be played (hereinafter also referred to as “target slide show”). Further, the user can instruct either slide show display for playing the target slide show, or thumbnail display for displaying thumbnails of photos included in the target slide show.

When the user has performed an operation of instructing the slide show display, the slide show selector 53 requests the server 10 to transmit data for playing the target slide show.

The slide show transmitter 412 of the server 10 delivers the slide show, which has been requested by the client 12, to the client 12. To be more specific, in response to the request by the client 12, the slide show transmitter 412 reads photos (photo data files) included in the target slide show from the storage device 405. For example, the slide show transmitter 412 detects, from the photo association data 408, entries including the slide show ID of the target slide show, thereby detecting the photo IDs of the photos in the slide show. Then, by referring to the photo data 406, the slide show transmitter 412 detects entries including the detected photo IDs, and reads the photo data files of the photos in the slide show, based on the file paths described in the “photo file path” of the entries. In addition, the slide show transmitter 412 outputs the photo IDs of the photos in the target slide show to the slide show reconstruction module 413.

Subsequently, the slide show reconstruction module 413 detects comments added to (associated with) the photos in the target slide show. For example, using the photo IDs of the photos in the target slide show, the slide show reconstruction module 413 determines whether comments are added to the photos.

FIG. 10 illustrates a configuration example of the comment data 409. The comment data 409 includes a plurality of entries corresponding to a plurality of comments. Each entry includes, for example, “comment ID”, “date”, “terminal ID” and “comment”. In an entry corresponding to a certain comment, the “comment ID” is indicative of identification information given to the comment. The “date” is indicative of a date on which the comment was generated. The “terminal ID” is indicative of identification information given to the terminal (client apparatus) by which the comment was generated. The “comment” is indicative of the description of the comment.

FIG. 11 illustrates a configuration example of comment association data 410. The comment association data 410 includes a plurality of entries corresponding to a plurality of comments. Each entry includes, for example, “registration ID” and “comment ID”. In an entry corresponding to a certain comment, the “registration ID” is indicative of identification information given to a combination of a slide show and a photo, to which the comment is added. The “comment ID” is indicative of identification information given to the comment. Specifically, it can be said that a certain comment is associated with a combination of a slide show and a photo, which are indicated in the “registration ID” in the entry of the photo association data 408.

Thus, by using the comment association data 410 and photo association data 408, it can be detected which photo in which slide show a certain comment is added to.

When a comment has not been added to the photos in the target slide show, the slide show reconstruction module 413 requests the slide show transmitter 412 to deliver data relating to the target slide show to the client 12 (first client). On the other hand, when comments have already been added to the photos in the target slide show, the slide show reconstruction module 413 requests the slide show transmitter 412 to deliver data relating to a slide show, which has been reconstructed based on the comments, to the client 12 (second client).

To begin with, a description is given of the case in which no comment is added to the photos in the target slide show.

When a comment has not been added to the photos in the target slide show, the slide show transmitter 412 transmits to the client 12 (first client), for example, the information indicative of the display order (first order) of photos, which was designated when the slide show was created, and the read photo data files.

The slide show playback module 55 of the client 12 receives the information indicative of the display order and the read photo data files from the server 10 (slide show transmitter 412), and plays the slide show by using these data. Specifically, the slide show playback module 55 sequentially displays on the screen the photos based on the photo data files, according to the display order (first order) of photos, which was designated when the slide show was created.

While the slide show (the photos in the slide show) is being displayed on the screen, the comment selector 57 accepts comments on the photos which are being displayed. For example, in accordance with an operation of pressing a first button (e.g. “blue” button 75B) on the remote controller 217, the comment selector 57 detects that a comment (e.g. “Good!”), which is associated with the first button, has been selected for the photo that is being displayed.

In addition, in accordance with an operation of pressing a second button (e.g. “green” button 75G) on the remote controller 217, the slide show playback module 55 pauses the slide show, and the comment display controller 56 displays a list of typical comments. This list of typical comments is a menu for selecting a comment from among a plurality of comment candidates. For example, in accordance with an operation of pressing the “up” button 74U or “down” button 74D on the remote controller 217, the comment selector 57 sets a comment among the comment candidates, which is to be added to the displayed photo, in a selected state. Then, the comment selector 57 detects that the comment in the selected state has been determined for the displayed photo, in accordance with an operation of pressing the “decision” button 741.

In response to the selection of the comment for the photo that is being displayed, the comment selector 57 registers this comment in the server 10. To be more specific, the comment selector 57 transmits to the server 10, for example, data including the slide show ID of the target slide show, the photo ID of the photo to which the comment has been added (the photo that is being displayed), and the comment.

The comment processor 414 of the server 10 receives the data including the slide show ID, photo ID and comment from the client 12. Then, the comment processor 414 adds the comment to the combination of the slide show and photo based on the slide show ID and photo ID.

To be more specific, the comment processor 414 generates an entry corresponding to the comment which has been transmitted from the client 12, and adds the entry to the comment data 409. Then, the comment processor 414 generates an entry including the comment ID of this added entry and the registration ID of the photo association data 408 corresponding to the combination of the slide show ID and photo ID which have been transmitted from the client 12, and adds this entry to the comment association data 410.

Thereby, the comment is added to the photo that is being displayed in the target slide show. A viewer can easily register comments on the photos in the slide show, even from a remote place, and can inform the creator of the slide show of his/her impression.

In the meantime, when the slide show is paused, the slide show playback module 55 of the client 12 may resume the slide show upon completion of adding of the comment on the photo that is being displayed.

Next, a description is given of the case in which comments have already been added to the photos in the target slide show.

When comments have already been added to the photos in the target slide show, the slide show reconstruction module 413 alters the slide show so that the target slide show includes the photos in an order (second order) based on the comments added to the photos. To be more specific, with respect to each of the photos in the target slide show, the slide show reconstruction module 413 calculates a display priority based on the number of comments, the kind of comment, the content of comment, etc. A high display priority is set for, for example, a photo with a large number of added comments, or a photo to which a positive comment (e.g. “Good!”, “Pretty!”) is added. A low display priority is set for, for example, a photo with a small number of added comments, or a photo to which a negative comment (e.g. “Sorry”) is added. The slide show reconstruction module 413 alters the slide show so that the photos are displayed in an order from a high display priority that is calculated (i.e. in a descending order of display priority).

The slide show transmitter 412 delivers the data relating to the altered slide show to the client 12 (second client). For example, the slide show transmitter 412 transmits to the client 12 the information indicative of the display order of photos altered by the slide show reconstruction module 413, and the photo data files of the photos in the slide show. The slide show transmitter 412 may further transmit to the client 12 information indicative of the comments added to the photos.

The slide show playback module 55 of the client 12 receives the information indicative of the display order and the photo data files from the server 10, and plays the slide show by using these data. To be more specific, the slide show playback module 55 sequentially displays on the screen the photos based on the photo data files, according to the display order (second order) of photos, which has been altered based on the comments. The comment display controller 56 can display, on the displayed photo, the comment which has been added to this photo. As has been described above, comments may further be added to the displayed photos in the slide show.

It can be assumed that photos, to which comments have been added, are photos in which the viewer has an interest. Thus, as described above, by reconstructing the slide show based on the comments (by altering the display order of photos in the slide show), a slide show, in which the interest of the viewer is taken into account, can be created without the creator performing any work. Therefore, by a simple operation in which the viewer adds comments, the structure of the slide show (e.g. the display order of photos) can be altered each time comments are added.

In addition, when the user has performed an operation of instructing thumbnail display, the slide show selector 53 of the client 12 determines a display method of thumbnails in accordance with a further select operation by the user. In the selection of the display method, the slide show selector 53 selects either a first method of displaying thumbnails in an order that was designated when the slide show was created, or a second method of displaying thumbnails in an order based on the comments added to the photos. The slide show selector 53 requests the server 10 to transmit data for displaying the thumbnails of the photos in the target slide show by the selected method.

When the method requested by the client 12 is the first method, the slide show transmitter 412 of the server 10 transmits to the client 12 the data including information indicative of the display order of photos which was designated when the slide show was created, and thumbnails of the photos in the target slide show. Incidentally, the slide show transmitter 412 may further transmit information indicative of a layout of thumbnails to the client 12.

The thumbnail display controller 54 of the client 12 displays a table of thumbnails of photos in the slide show, based on the display order (and layout) of photos transmitted from the server 10.

On the other hand, when the method requested by the client 12 is the second method, the slide show reconstruction module 413 calculates, as described above, the display priority based on the number of comments, the kind of comment, the content of comment, etc., with respect to each of the photos in the target slide show. The slide show reconstruction module 413 determines the display order of photos based on comments, according to the order from a high display priority (i.e. in a descending order of display priority). Then, the slide show transmitter 412 transmits to the client 12 the data including information indicative of the determined display order of photos based on the comments, and thumbnails of the photos in the target slide show. Incidentally, the slide show transmitter 412 may further transmit to the client 12 information indicative of the display size of each thumbnail (e.g. a larger display size for a photo with a higher display priority), and information indicative of the layout of thumbnails, which have been determined based on the calculated display priority.

The thumbnail display controller 54 of the client 12 displays a table of thumbnails of the photos in the slide show, based on the display order (and layout and display size) of photos, which has been transmitted from the server 10.

When the thumbnail table of the slide show is being displayed, the slide show playback module 55 of the client 12 can start playback of the slide show in accordance with a user's operation of requesting playback of the slide show. In addition, the comment selector 57 can register comments, which have been added to the thumbnails, in the server 10.

The above description has been given of the case in which in the second-type client 12 the slide show is played and comments are added to the photos in the slide show. The similar operations, however, can be executed in the first-type client 11. Specifically, the first-type client 11 may further include the above-described configuration of the second-type client 12. The first-type client 11 can download a slide show from the server 10, can display the slide show or a thumbnail table of the slide show, and can add comments to the photos in the slide show. The operations of the first-type client 11 at this case are similar to the above-described operations of the second-type client 12.

FIG. 12 illustrates an example of a slide show creation screen 61 for instructing creation of a slide show, the slide show creation screen 61 being displayed by the creation screen display controller 313 of the first-type client 11. The slide show creation screen 61 includes a title input area 611, a comment input area 612, a date select button 613, a permitted client select area 614, a create button 615, and a cancel button 616.

The title input area 611 is an area for inputting a title which is to be given to the slide show. The comment input area 612 is an area for inputting a description such as a general description or an introduction of the slide show. The date select button 613 is a button for selecting a date relating to the slide show (year, month and day). With the date select button 613, for example, not a date on which the slide show was created, but a date of an event in which photos used in the slide show were taken, is set. The permitted client select area 614 includes a check box which indicates client candidate which are permitted to browse the slide show. Each of the candidates is represented by the name given to the candidate, so that the user may easily identify the candidate. As this name, for example, use is made of a place where the client apparatus is used, or a nickname based on the user who uses the client apparatus (e.g. “Mr. XX's home”, “Mr. XX”, “XX of Tokyo”).

The create button 615 is a button for requesting the server 10 to create a slide show based on the content input on the slide show creation screen 61. The cancel button 616 is a button for canceling creation of the slide show.

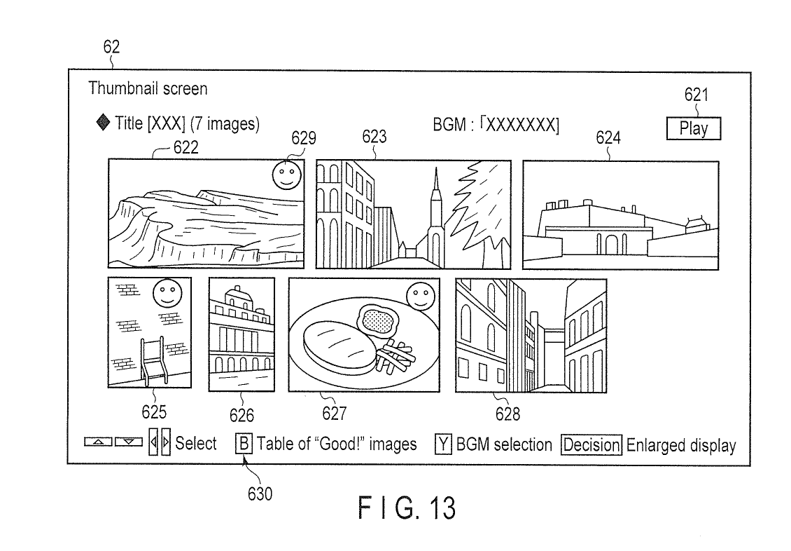

FIG. 13 illustrates a thumbnail screen 62 corresponding to a target slide show displayed by the thumbnail display controller 54 of the client 11, 12. The thumbnail screen 62 includes, for example, a play button 621, thumbnails 622 to 628, and operation information 630.

The thumbnails 622 to 628 are thumbnails corresponding to photos included in the slide show. In addition, a mark 629 indicative of addition of comments is displayed on thumbnails 622, 625 and 627 corresponding to photos to which comments are added. The play button 621 is a button for instructing play of a slide show corresponding to the displayed thumbnails.

The operation information 630 includes information relating to various operations on the thumbnail screen 62. For example, the operation information 630 includes information indicative of buttons on the remote controller 217, which are associated with various operations on the thumbnail screen 62. In the example illustrated in FIG. 13, the operation information 630 indicates that a thumbnail is set in a selected state by operations of pressing the “up” button 74U, “down” button 74D, “left” button 74L and “right” button 74R. The operation information 630 indicates that a list of thumbnails to which comments are added (e.g. a list of thumbnails to which comment “Good!” is added) is displayed by an operation of pressing the “blue” button 75B. The operation information 630 indicates that a dialog for selecting BGM is displayed by an operation of pressing the “yellow” button 75Y. In addition, the operation information 630 indicates that a thumbnail in a selected state is enlarged and displayed by an operation of pressing the “decision” button 741 (e.g. the photo corresponding to a thumbnail in a selected state is displayed on the entire screen).

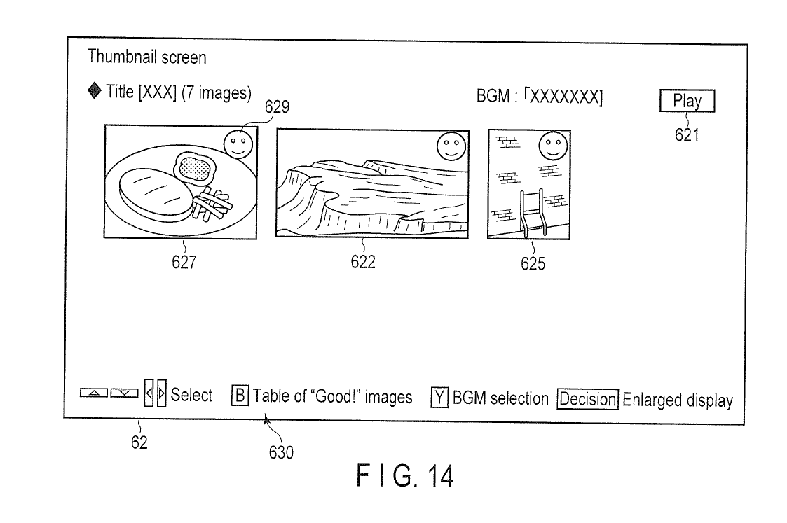

For example, as illustrated in FIG. 14, in the case where the “blue” button 75B has been pressed when the thumbnail screen 62 is displayed, a thumbnail screen 64 including only the thumbnails to which comments are added is displayed. By this thumbnail screen 64, the user can browse, for example, only the photos in which other users had interest.

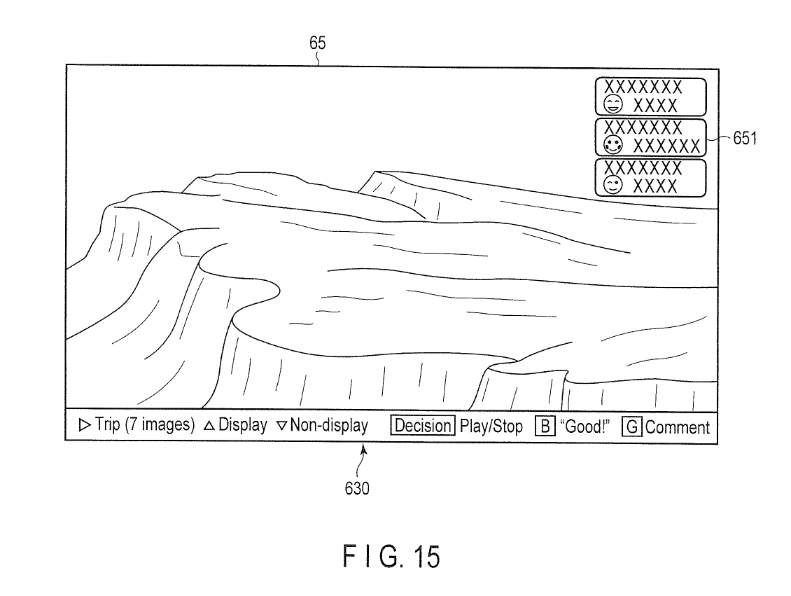

In addition, as illustrated in FIG. 15, in the case where the “decision” button 741 has been pressed when the thumbnail screen 62 is displayed, a slide show playback screen 65 including the photo corresponding to the thumbnail 622, which is set in the selected state, is displayed. On the slide show playback screen 65, comments 651, which are added to the displayed photo, are displayed such that the comments 651 are superimposed on the displayed photo.

The slide show playback screen 65 includes operation information 630. For example, the operation information 630 indicates that the slide show is played/stopped by an operation of pressing the “decision” button 741. The operation information 630 indicates that a specific comment (e.g. comment “Good!”) is added to the displayed photo by an operation of pressing the “blue” button 75B. The operation information 630 indicates that a list of comment candidates (comment menu) is displayed by an operation of pressing the “green” button 75G.

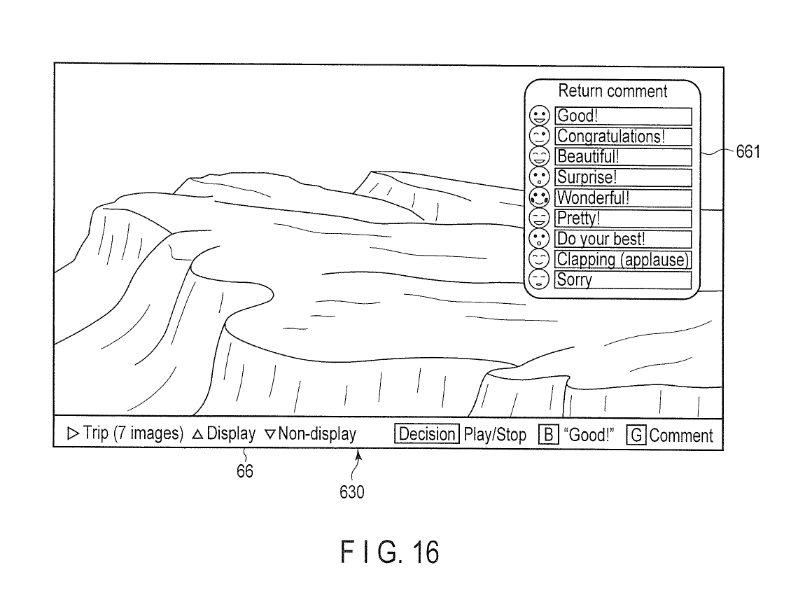

As illustrated in FIG. 16, in the case where the “green” button 75G has been pressed when the slide show playback screen 65 is displayed, a list 661 of typical comment candidates (comment menu) is displayed. For example, by using the “up” button 74U or “down” button 74D on the remote controller 217, the user selects, from among the comment candidates, a comment which is to be added to the displayed photo, and determines, by using the “decision” button 741, that the selected comment is added to the displayed photo. The client 11, 12 registers the comment added to the displayed photo in the server 10. The server 10 stores in the storage the photo in the slide show which is being played (displayed) in the client 11, 12, and the comment selected on the client 11, 12, by mutually associating the photo and the comment.

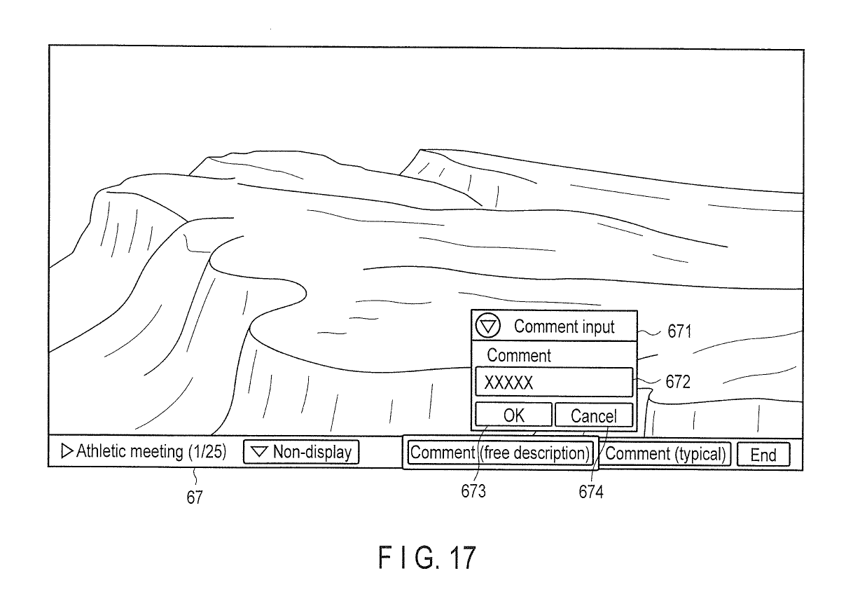

The comment that is to be added to the photo may be not only the typical comment selected from the list 661 of comment candidates, but also a comment freely described by using a keyboard or the like. A slide show playback screen 67 illustrated in FIG. 17 displays a comment input dialog 671 including a comment input area 672, an OK button 673 and a cancel button 674. By an operation of pressing the OK button 673 after describing a comment in the comment input area 672 by using the keyboard (software keyboard) or the like, the user can add a free comment to the photo that is being displayed. The server 10 stores in the storage the photo in the slide show which is being played (displayed) in the client 11, 12, and the comment which has been input on the client 11, 12, by mutually associating the photo and the comment.

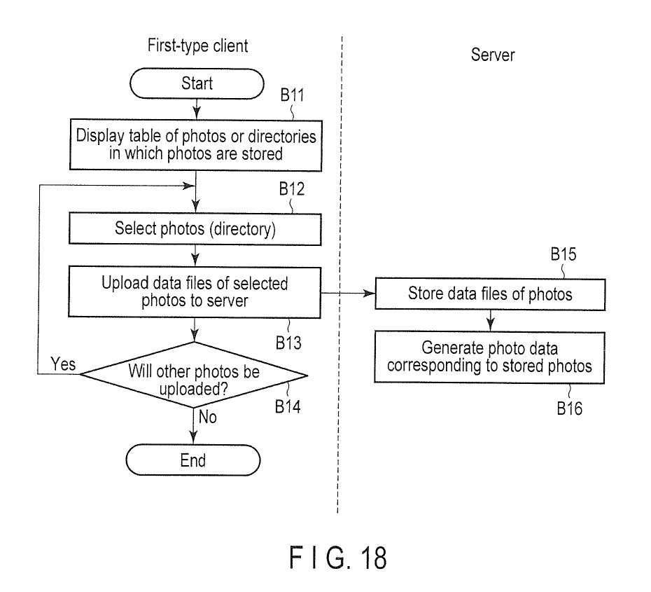

Next, referring to FIG. 18, a description is given of a process procedure of uploading photos from the first-type client 11 to the server 10.

To start with, the photo display controller 302 of the client 11 displays a table of photos (images) and/or directories in which photos are stored (block B11). In accordance with a user's operation, the upload photo selector 303 selects, from the displayed table, photos and/or a directory in which photos are stored (block B12). Then, the photo upload module 304 transmits (uploads) to the server 10 photo data files of the selected photos and/or photo data files of photos stored in the selected directory (block B13).

In addition, the upload photo selector 303 determines whether other photos are to be uploaded or not (block B14). When other photos are uploaded (i.e. when photos or a directory is further selected by the user) (YES in block B14), the process returns to block B12, and a process for further uploading photo data to the server is executed. On the other hand, when other photos are not uploaded (i.e. when the selection of photos or a direction by the user is completed) (NO in block B14), the process is terminated.

The photo storing processor 402 of the server 10 receives photo data files that have been transmitted from the client 11, and stores the photo data files in the storage device 405 (block B15). Then, the photo storing processor 402 generates photo data 406 corresponding to the stored photos (block B16).

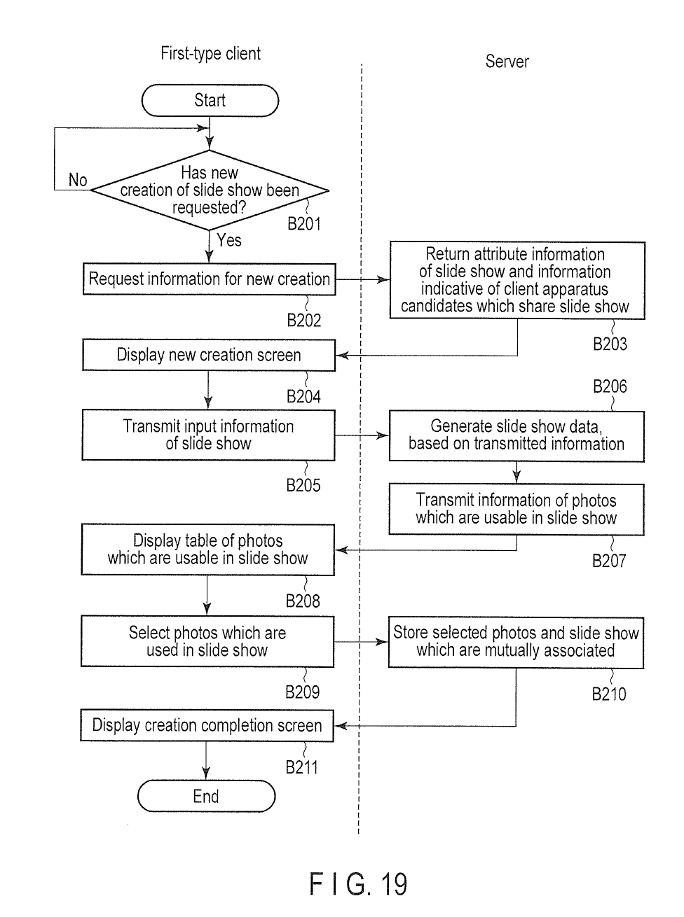

FIG. 19 illustrates a process procedure in which the server 10 creates a slide show in response to a request by the first-type client 11.

To start with, the slide show information transmitter/receiver 312 of the client 11 determines whether new creation of a slide show has been requested or not (block B201). For example, the slide show information transmitter/receiver 312 determines whether a user's operation for starting new creation of a slide show has been detected or not. When new creation of a slide show has not been requested (NO in block B201), the process returns to block B201, and it is determined once again whether new creation of a slide show has been requested or not.

On the other hand, when new creation of a slide show has been requested (YES in block B201), the slide show information transmitter/receiver 312 requests the server 10 to send information for newly creating a slide show (block B202). In response to the request by the client 11, the slide show generator 403 of the server 10 transmits to the client 11 attribute information of a slide show and information indicative of candidates of client apparatuses that share the slide show (block B203).

The slide show information transmitter/receiver 312 of the client 11 receives the information which has been transmitted from the server 10, and the creation screen display controller 313 displays a slide show creation screen (new creation screen) 61 by using the received information (block B204). Using the keyboard or pointing device, the user inputs a title of a slide show, etc. on the slide show creation screen 61, and selects client apparatuses permitted to browse the slide show. The slide show information transmitter/receiver 312 transmits the information for slide show creation, which has been input on the slide show creation screen 61, to the server 10 (block B205).

The slide show generator 403 of the server 10 generates slide show data 407, based on the information transmitted from the client 11 (block B206). Then, the slide show generator 403 transmits to the client 11 information indicative of photos which are usable in the slide show corresponding to the generated slide show data 407 (block B207).

The creation screen display controller 313 of the client 11 displays a table of photos usable in the created slide show, based on the information from the server 10, which is indicative of photos usable in the slide show (block B208). Then, in accordance with a select operation by the user, the slide show photo selector 314 selects photos which are used in the slide show, and transmits information indicative of the selected photos to the server 10 (block B209).

Subsequently, based on the information transmitted from the client 11, the photo registration module 404 of the server 10 stores the photos selected by the client 11 (the photos used in the slide show) and the created slide show by mutually associating the photos and the slide show (block B210). To be more specific, the photo registration module 404 generates an entry including photo IDs corresponding to the photos selected by the client 11 and a slide show ID corresponding to the created slide show, and then adds the generated entry to the photo association data 408. Thereby, the photos in the created slide show can be specified. The photo registration module 404 notifies the client 11 of the completion of photo registration for the slide show.

In response to the notification from the server 10, the slide show photo selector 314 of the client 11 causes the creation screen display controller 313 to display a creation completion screen of the slide show (block B211).

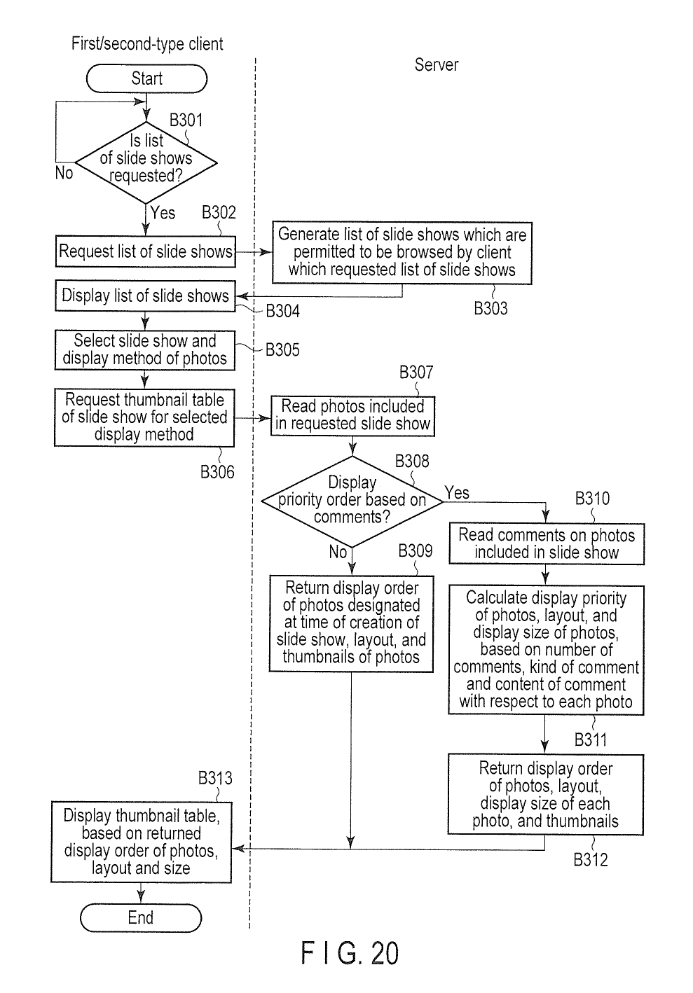

Next, referring to FIG. 20, a description is given of a process procedure of a process in which thumbnails of a slide show are transmitted from the server 10 in response to a request by the first-type client 11 or second-type client 12.

To start with, the list request module 51 of the client 11, 12 determines whether or not to request the server 10 to send a list of slide shows which can be browsed (played back) by the client 11, 12 (block B301). When a list of slide shows is not requested (NO in block B301), the process returns to block B301, and it is determined once again whether or not to request the server 10 to send a list of slide shows.

On the other hand, when a list of slide shows is requested (YES in block B301), the list request module 51 of the client 11, 12 requests the server 10 to send a list of slide shows, which can be browsed by the client 11, 12 (block B302).

In response to the request by the client 11, 12, the list processor 411 of the server 10 generates a list of slide shows which are permitted to be browsed by the client 11, 12, and then transmits the list to the client 11, 12 which has requested the list (block B303). For example, referring to the slide show data 407, the list processor 411 detects slide shows (slide show IDs) of entries in which the ID of the client 11, 12 is set in “permitted terminal ID”, thereby generating a list of slide shows.

Then, the list display controller 52 of the client 11, 12 displays the list, which has been transmitted from the server 10, on the screen (block B304). In response to a select operation by the user, the slide show selector 53 selects a slide show and a display method of photos (thumbnails) in the slide show (block B305). In the selection of the display method, selection is made either a method of displaying photos in an order (first order) which was designated when the slide show was created or a method of displaying photos in an order (second order) based on comments added to the photos. The slide show selector 53 requests the server 10 to send a thumbnail table of the slide show by the selected display method (block B306).

The slide show transmitter 412 of the server 10 reads photos (photo data files) in the requested slide show from the storage device 405 (block B307). For example, the slide show transmitter 412 detects, from the photo association data 408, entries including the slide show ID of the requested slide show, thereby detecting the photo IDs of the photos in the slide show. Then, the slide show transmitter 412 detects, from the photo data 406, entries including the detected photo IDs, and then reads the photo data files, based on the file paths described in the “photo file path” of the detected entries.

Subsequently, the slide show transmitter 412 determines whether the display method of photos, which has been requested by the client 11, 12, is a second method of displaying photos in an order (display priority order) based on comments (block B308). When the display method is not the method of displaying photos in the order based on comments (i.e. when the display method is a method of displaying photos in the order designated when the slide show was created) (NO in block B308), the slide show transmitter 412 transmits first data (block B309). The first data corresponds to the display order of photos designated when the slide show was created, the layout of photos and thumbnails (reduced images) of photos, to the requested client 11, 12. Based on the display order and layout of photos transmitted from the server 10, the thumbnail display controller 54 of the client 11, 12 displays a table of thumbnails of photos in the slide show (block B313).

On the other hand, when the display method is the method of displaying photos in the order based on comments (YES in block B308), the slide show reconstruction module 413 reads comments which are added to photos in the slide show, by referring to the comment data 409 (block B310). Then, based on the number of comments on each photo, the kind of comment and the content of comment, the slide show reconstruction module 413 calculates a display order (display priority) of photos, layout and display size (block B311). The slide show transmitter 412 transmits the data, which corresponds to the calculated display order of photos, layout, display size and thumbnails (reduced images) of photos, to the requested client 11, 12 (block B312). Based on the display order, layout and display size transmitted from the server 10, the thumbnail display controller 54 of the client 11, 12 displays a table of thumbnails of photos in the slide show (block B313).

In the meantime, when the thumbnail table of the slide show is being displayed, the slide show playback module 55 of the client 11, 12 can start playback of the slide show in accordance with a user's operation of requesting playback of the slide show.

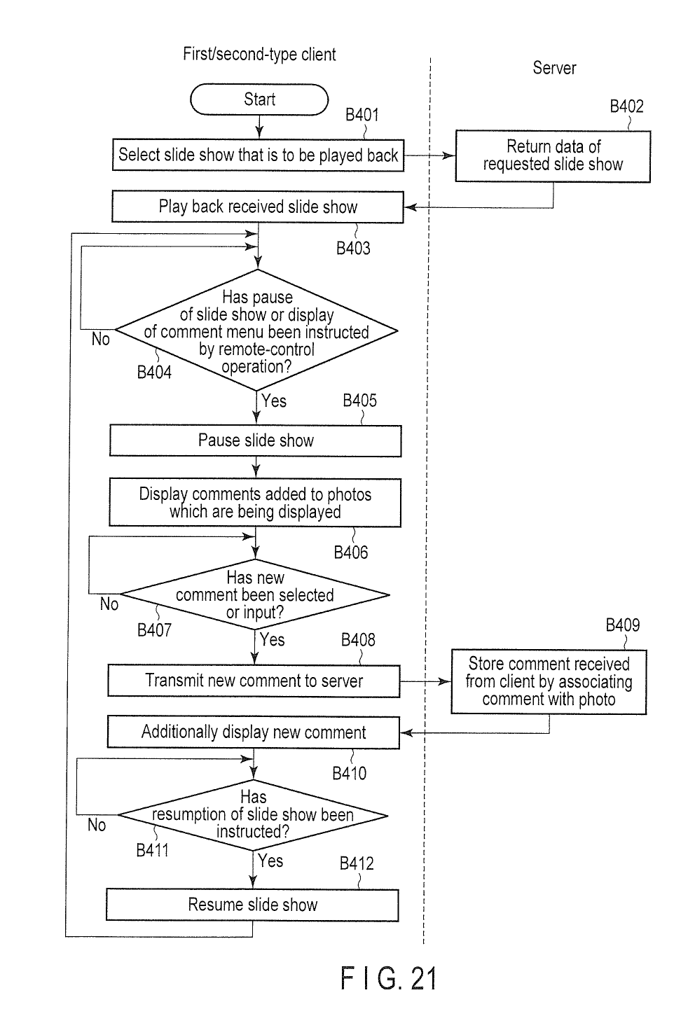

Next, referring to FIG. 21, a description is given of a process procedure of a process of adding comments to photos in the slide show in accordance with a request by the first-type client 11 or second-type client 12.

To start with, the slide show selector 53 of the client 11, 12 selects a slide show which is a target of playback (hereinafter also referred to as “target slideshow”), and requests data of the target slide show (block B401). For example, like the process of blocks B301 to B304 in FIG. 20, the slide show selector 53 selects a target slide show from the list in accordance with a select operation by the user. In the meantime, the slide show selector 53 may detect, as selection of the target slide show, a user operation of requesting playback of a slide show when the thumbnail table of the slide show is displayed in the process of block B313 in FIG. 20.

The slide show transmitter 412 of the server 10 transmits the data of the requested slide show to the client 11, 12 (block B402). The transmitted data of the slide show includes, for example, data files of photos in the slide show and data indicative of a display order of the photos. In addition, the transmitted data of the slide show, may includes moving picture data in which photos in the slide show are sequentially displayed. The slide show playback module 55 of the client 11, 12 plays the slide show by using the received data of the slide show (block B403).

Then, the slide show playback module 55 determines whether pause of the slide show or menu display of comments has been instructed by a user's operation with use of the remote controller 217 or the like (block B404). When neither pause of the slide show nor menu display of comments has been instructed (NO in block B404), the process returns to block B404, and it is determined once again whether pause of the slide show or menu display of comments has been instructed or not.

On the other hand, either pause of the slide show or menu display of comments has been instructed (YES in block B404), the slide show playback module 55 pauses the slide show which is being played (block B405). Then, when comments are already added to the photos which are being displayed, the comment display controller 56 displays the comments 651 (block B406). The data relating to the displayed comments is included, for example, in the data of the slide show transmitted from the server 10. In addition, when menu display of comments has been instructed, the comment display controller 56 displays a list 661 of typical comments. Incidentally, the comment display controller 56 may display the comment input dialog 671 for freely inputting comments.

Subsequently, the comment selector 57 determines whether a new comment has been selected or input (block B407). When no new comment has been selected or input (NO in block B407), the process returns to block B407, and it is determined once again whether a new comment has been selected or input.

When a new comment has been selected or input (YES in block B407), the comment selector 57 transmits the new comment to the server 10 (block B408). To be more specific, the comment selector 57 transmits to the server 10, for example, data including the slide show ID of the present target slide show, the photo ID of the photo to which the comment has been added (the photo that is being displayed), and the comment.

The comment processor 414 of the server 10 stores the comment transmitted from the client 11, 12 by associating the comment with the photo to which the comment has been added (block B409). For example, the comment processor 414 adds an entry corresponding to the comment, which has been transmitted from the client 11, 12, to the comment data 409. Then, the comment processor 414 adds to the comment association data 410 an entry for associating the comment ID of this added entry with the combination of the slide show ID and photo ID which have been transmitted from the client 11, 12. Thereby, the comment can be associated with the photo in the slide show.

In addition, the comment display controller 56 of the client 11, 12 additionally displays the new selected or input comment on the photo that is being displayed (block B410). Then, the slide show playback module 55 determines whether resumption of the paused slide show has been instructed or not (block B411). If resumption of the paused slide show is not instructed (NO in block B411), the process returns to block B411, and it is determined once again whether resumption of the paused slide show has been instructed or not. On the other hand, when resumption of the paused slide show has been instructed (YES in block B411), the slide show playback module 55 resumes the slide show from a time point at which the slide show was paused (block B412). The user can further add a comment to the photo displayed in the resumed slide show.

As has been described above, according to the present embodiment, a slide show, in which an interest of the user is taken into account, can be created. When the user of the client 11, 12 browses the slide show which has been delivered from the server 10, the user can add comments to each of photos in the slide show. Based on the comments added to the photos, the server 10 alters the display order of photos in the slide show. Accordingly, when the slide show, to which comments are added, is browsed, the user can browse the slide show in which the display order of photos has been altered based on the comments. Thus, for example, when a plurality of users have added comments to a certain slide show, it is possible to create a slide show which preferentially displays a photo in which the plural users have much interest.

In addition, comments, which have been added by various viewers, can be displayed on the photos in the slide show. Thus, the comments (impressions) can be shared among plural viewers who view the slide show, as well as the creator of the slide show, and a feeling of synchronism of browsing can be obtained. Moreover, the creator can feel, for example, a joy of being evaluated by viewers.

All the process procedures in the present embodiment, which have been described with reference to the flowcharts of FIGS. 18 to 21, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an image storing processor configured to receive an image from one or more client apparatuses connected via a network, and to store first images comprising the received image;
a slide show transmitter configured to generate a slide show comprising second images selected from the first images and to transmit the slide show to a first client apparatus of the one or more client apparatuses, the slide show comprising the second images in a first order; and
a comment receiver configured to receive one or more comments from the first client apparatus, wherein the one or more comments are associated with one or more images of the second images,
wherein the slide show transmitter is configured to alter the slide show such that the slide show comprises the second images in a second order based on the one or more comments, and to transmit the altered slide show to a second client apparatus of the one or more client apparatuses.

2. The information processing apparatus of claim 1, wherein the slide show transmitter is configured to be capable of transmitting the slide show to a permitted client apparatus of the one or more client apparatuses.

3. The information processing apparatus of claim 1, wherein a third client apparatus of the one or more client apparatuses is configured to designate the second images and the first order.

4. The information processing apparatus of claim 1, wherein the second order is an order of high display priority based on a number of comments associated with each of the second images.

5. An electronic apparatus connected to a server via a network, the electronic apparatus comprising:
a slide show playback module configured to receive a slide show comprising images in a first order from the server, and to display the images on a screen in the first order; and
a comment transmitter configured to transmit information indicative of a first image being displayed on the screen and a first comment to the server when having received a first signal from a remote controller for operating the electronic apparatus, the first signal being for associating the first comment with the first image.

6. The electronic apparatus of claim 5, further comprising a menu display controller configured to display a menu comprising comment candidates on the first image being displayed on the screen when having received a signal from the remote controller, the signal being for displaying the menu,
wherein the comment transmitter is configured to transmit the information indicative of the first image and a comment corresponding to a first candidate of the comment candidates to the server when having received a second signal from the remote controller, the second signal being for selecting the first candidate from the comment candidates.

7. The electronic apparatus of claim 5, wherein the slide show playback module is configured to further display the first comment on the first image.

8. An image management method comprising:
receiving an image from one or more client apparatuses connected via a network, and storing first images comprising the received image;
generating a slide show comprising second images selected from the first images and transmitting the slide show to a first client apparatus of the one or more client apparatuses, the slide show comprising the second images in a first order; and
receiving one or more comments from the first client apparatus, wherein the one or more comments are associated with one or more images of the second images,
wherein generating and transmitting the slide show comprises altering the slide show such that the slide show comprises the second images in a second order based on the one or more comments, and transmitting the altered slide show to a second client apparatus of the one or more client apparatuses.

9. The image management method of claim 8, wherein transmitting the slide show comprises transmitting the slide show to a permitted client apparatus of the one or more client apparatuses.

10. The image management method of claim 8, wherein a third client apparatus of the one or more client apparatuses is configured to designate the second images and the first order.

11. The image management method of claim 8, wherein the second order is an order of high display priority based on a number of comments associated with each of the second images.

12. A computer-readable, non-transitory storage medium having stored thereon a program which is executable by a computer, the program controlling the computer to execute functions of:
receiving an image from one or more client apparatuses connected via a network, and storing first images comprising the received image;
generating a slide show comprising second images selected from the first images and transmitting the slide show to a first client apparatus of the one or more client apparatuses, the slide show comprising the second images in a first order; and
receiving one or more comments from the first client apparatus, wherein the one or more comments are associated with one or more images of the second images,
wherein transmitting the slide show comprises altering the slide show such that the slide show comprises the second images in a second order based on the one or more comments, and transmitting the altered slide show to a second client apparatus of the one or more client apparatuses.

13. The storage medium of claim 12, wherein transmitting the slide show comprises transmitting the slide show to a permitted client apparatus of the one or more client apparatuses.

14. The storage medium of claim 12, wherein a third client apparatus of the one or more client apparatuses is configured to designate the second images and the first order.

15. The storage medium of claim 12, wherein the second order is an order of high display priority based on a number of comments associated with each of the images.
